(19) United States
(12) Patent Application Publication
(10) Pub. No.: US 2026/0348159 A1
(43) Pub. Date: Nov. 5, 2026

(54) PANEL SYSTEM CONFIGURED TO ALLOW ADJUSTABLY POSITIONING OF loT DEVICES

(71) Applicant: B Bond Beyond Technology Ltd, Dubai (AE)

(72) Inventors: Dechawathr DULSAPSOPONT, Bangkok (TH); Surachai THONGKAEW, Lam Luk Ka, Pathum Thani (TH)

(73) Assignee: B Bond Beyond Technology Ltd, Dubai (AE)

(21) Appl. No.: 19/118,018

(22) PCT Filed: May 20, 2022
(86) PCT No.: PCT/TH2022/000021

§ 371 Date: Apr. 3, 2025

(51) Int. Cl. E04C 2/52; H02G 3/38

(52) U.S. Cl. CPC E04C 2/521; H02G 3/28

(57) ABSTRACT

The present invention relates to an IoT based panel system for making a panel integrated with cable module to connect IoT devices. The IoT based panel system (100) comprises:
a supporting panel (200);
at least one mounting module (300) installed on the supporting panel (200) for mounting IoT devices thereon;
at least one cable track (350) formed at at least one edge of the mounting module (300) for supporting a cable module (400);
the cable module (400) installed in the cable track (350), where the cable module (400) comprises at least one cable (402) and at least one junction unit
   wherein the cable module (400) is fully or partially installed in the cable track (350) in a predetermined direction to transmit power and signal to an adjustably predetermined position of the IoT devices.

### FIELD OF INVENTION

The present invention relates to an IoT based panel system for making a panel integrated with cable module to connect IoT devices, especially in the construction field.

### BACKGROUND OF INVENTION

A house or building structure always comprises walls which are made of brick and concrete. The walls can be decorated with tile, wood or painting for interior design purposes. Installation and dismantling of the wall requires expert technicians to carry out the construction which consumes a lot of time with high labor costs. When a householder needs to renovate their house, the walls sometimes need to be demolished and cannot be recycled and reused. In addition, dust from demolition is considered as pollution waste.

Nowadays there are walls being developed using frames and covered with panel plates in order to reduce the use of concrete, and also integrating with internet of things (IOT) devices providing smart home facilities to residents. Currently, devices such as sensors, touch screen displays, speakers, or smart appliances, are installed onto walls by mounting with screws and wiring to a power supply. Those devices cause inconvenience to the householder because there is a need to drill the wall for installation, creating an unattractive interior mark on the wall which cannot be concealed. In case that the householder wants to remove the devices, it is necessary to fill and re-paint drilled holes. Moreover, electronic wiring connection of those IoT devices requires a skilled technician to select cables for correct installation. Sometime those cables have different types of communications protocol that cause complex connections, difficult replacement, and cause plurality of cables that can be clearly seen on the wall. Therefore, a panel system is being developed which can replace traditional walls. The panel system is designed and assembled to replace walls, floors or ceilings without the need of a skilled technician. The panel plate of the system can also be disassembled, reinstalled and reused without any hand tools and without having to worry about construction and destruction issues. In addition, the panel plate of the system may be embedded with IoT devices with a redesigned electrical system in the wall in order to facilitate and respond to the householder's lifestyle without causing any damage to the wall.

However, building the above panel system requires a supporting of plates and unique cables for arranging system connection. Because the standard connecting cable available in the market comprises commonly used electrical cables which are embedded into traditional walls, and cannot be integrated via one type of cable for the whole panel system, this cannot solve the technical problem of the panel system.

U.S. Pat. No. 9,487,949B2 disclosed a panel wall system for partition arrangements that is adaptable to suit a wide variety of spaces and user preferences. Partition panels are connected in different configurations to form the wall. The partition panels are durable and can be readily disassembled and reassembled into alternative configurations to meet user requirements. The panel wall system comprises a frame formed by assembling a plurality of vertical frame members and horizontal frame members, plurality of panel members which are attached to the frame by latch mechanisms to cover the frame where the panel members can be different sizes. Additionally, the panel wall system further comprises power blocks for installation of electronic devices on the panel system, where wiring cables of the power blocks are routed through the vertical frame members and the horizontal frame members. However, it is silent about applying a cable module having cables and junction units to be fully or partially integrated into a panel system in order to transmit both power and signal to predetermined position of the IoT devices, where the panel system is designed to allow adjustably positioning of IoT devices.

US20180343741A1 disclosed an array connection of rigid-flex printed circuit board (PCB) in electronic devices by using a flexible PCB formed into flexible connectors as a straight type or 4-way junction type, wherein each connecting part includes power pin (VCC) for electric supply, ground (GND) pin, and multiple signal lines for data communication. This flexible PCB is used as a replacement for traditional cable connecting parts in restricted spaces and tightly positioned electronic devices. The flexible PCB may be multilayer structure to carry required communication comprising one or more layers of conductors, typically copper, separated by insulting layers such as glass, epoxy, or polyimide. For example, four-layer PCB with three intervening insulation layers, where the outer copper layer can be coated with a protective layer for protection against corrosion. However, it does not teach applying fully or partially arranging of a cable module to be installed in the panel system, where the panel system is designed to allow adjustably positioning of IoT devices and connected to the cable module for being function at the same time.

In order to improve the disadvantages discussed above, this invention develops an IoT based panel system to replace a traditional construction and function as the panel system for arranging a cable module to connect with IoT devices, where the panel system is designed to allow adjustable positioning of IoT devices so that a user can move the IoT devices to any position on the panel any time when required. This contrasts to the current system where the IoT devices must be fixed at positions in accordance with the electrical wiring only. In addition, the cable module comprises a cable and junction unit with specific pin of connecting parts for providing circuitry to effectively connect IoT devices over the system.

### SUMMARY OF THE INVENTION

Nowadays in the digital world, IoT devices have been widely utilized and became more common among the consumers. IoT devices including display devices (e.g. televisions and the likes), video projectors and audio systems, electrical devices (e.g. one or more lights, air conditioners, fans, kitchen devices) need to be installed in houses, resident rooms (such as house rooms, condominium rooms, apartment rooms or hotel rooms, theater rooms, showrooms, and the likes in order to create smart rooms for living, gaming, or other activities. In addition, users may sometimes want to redesign and rearrange such devices in their house/rooms by moving the devices from one position to another position, and installing additional devices to support their needs. Existing panel systems, which are only cement-based panels with an electric wire system embedded in some parts of the panel, cannot adequately address such needs due to a number of limitations such as the need for wall drilling and wall concealing for installation, need of additional wiring on the wall to transmit signal among devices, and likes. Therefore, the present invention is developed to address such problems.

The present invention relates to an IoT based panel system for making a panel integrated with cable module to connect IoT devices. The IoT based panel system (100) comprises:
a supporting panel (200);
at least one mounting module (300) installed on the supporting panel (200) for mounting IoT devices thereon;
at least one cable track (350) formed at at least one edge of the mounting module (300) for supporting a cable module (400);
the cable module (400) installed in the cable track (350), where the cable module (400) comprises at least one cable (402) and at least one junction unit (404);
wherein the cable module (400) is fully or partially installed in the cable track (350) in a predetermined direction to transmit power and signal to an adjustably predetermined position of the IoT devices.

### BRIEF DESCRIPTION OF THE DRAWINGS

For a more complete understanding of the present invention, examples of embodiments, and their advantages, reference is made to the following description taken in conjunction with the accompanying drawings, in which like reference numbers indicate like features. The following figures show perspective views of the example embodiments.

FIG. 1 shows a perspective view of an IoT based panel system (100) according to the exemplary embodiments of the invention.

FIG. 2 shows a perspective view of (a) a supporting panel (200) and (b) the supporting panel (200) with an additional panel (202) according to the exemplary embodiments of the invention.

FIG. 3 shows examples of a mounting module (300) according to the exemplary embodiments of the invention.

FIG. 4 shows a cable module (400) installed in the cable track (350) according to the exemplary embodiments of the invention.

FIG. 5 shows an example of a cable (402) according to the exemplary embodiments of the invention.

FIG. 6 shows an example of a junction unit (404) according to the exemplary embodiments of the invention.

FIG. 7 shows an example of a connecting part (406) according to the exemplary embodiments of the invention.

FIG. 8 shows an example structure of the cable (402) according to the exemplary embodiments of the invention.

FIG. 9 shows an example structure of the junction unit (404) according to the exemplary embodiments of the invention.

Although similar reference numbers may be used to refer to similar elements in the figures for convenience, each of the various example embodiments may be considered to be distinct variations.

### DETAILED DESCRIPTION OF THE INVENTION

The present disclosure relates to an IoT based panel system (100) which allows users to adjust IoT devices attached on the IoT based panel system (100) from one position to another, which provides more flexibility, convenience and safety to users. The IoT based panel system (100) is configured to transmit power and signal to any IoT devices installed at any position thereon. Since the panel system (100) can be configured to systematically support connecting with multiple IoT devices, including display devices (e.g. televisions and the likes), video projectors and audio system (e.g. one or more speakers), other electrical devices (e.g. one or more lights, air conditioners, fans, kitchen devices), the panel system (100) may be installed in not only resident rooms (such as house rooms, condominium rooms, apartment rooms or hotel rooms), but also theater rooms, show rooms, exhibition rooms or rooms at an event. In addition, the IoT based panel system (100) may be used as a standalone panel, such as room divider or display stand mockup.

Any aspect shown herein is meant to include its application to other aspects of this invention unless stated otherwise.

Technical terms or scientific terms used herein have definitions as known to an ordinary person skilled in the art unless stated otherwise.

Any tools, equipment, methods, or chemicals named herein mean tools, equipment, methods, or chemicals being used commonly by an ordinary person skilled in the art unless expressly stated that they are tools, equipment, methods, or chemicals specific only to this invention.

Use of a singular noun or pronoun with “comprising” in claims or specification means “one” but may also refer to “one or more,” “at least one,” and “one or more than one.”

All components and/or methods disclosed and claims in this application aim to cover embodiments from any action, performance, modification, or adjustment without any experiment that significantly differs from this invention, which would result in creation of an object with the same utility or which would be deemed substantially similar to the present embodiment according to an ordinary person skilled in the art, whether or not such variation is specifically stated in the claims. Therefore, objects that are similar or which may be substitutable for the present embodiment, including those with minor modifications or adjustments that may be clearly devised by an ordinary person skilled in the art should be construed as being within the spirit, scope, and concept of invention as appeared in the appended claims.

Throughout this application, the term “about” means any number referenced herein that could be varied or deviated from any error of equipment, method, or person using said equipment or method.

Example aspects will now be described with reference to the accompanying drawings, which form a part of the present disclosure and which illustrate example embodiments which may be used. As used in the present disclosure and the appended claims, the terms “example embodiment,” “exemplary embodiment,” and “present embodiment” do not necessarily refer to a single embodiment, although they may, and various example embodiments may be readily combined and/or interchanged without departing from the scope or spirit of example embodiments. Furthermore, the terminology as used in the present disclosure and the appended claims are for the purpose of describing example embodiments only, and is not intended to limit interpretation. In this respect, as used in the present disclosure and the appended claims, the term “in” may include “in” and “on,” and the terms “a,” “an,” and “the” may each refer to the singular and plural. Furthermore, as used in the present disclosure and the appended claims, the term “by” may also mean “from,” depending on the context; the term “if” may also mean “when” or “upon,” depending on the context; and the term “and/or” may refer to and encompass any and all possible combinations of one or more of the associated listed items.

The term IoT devices used in the present disclosure include all electrical devices which need or need not connect to the internet, for example display devices (e.g. television, touch screen displays and the like), video projectors and audio systems, closed-circuit television (CCTV), surveillance cameras, solar cells, solar panels, chargers, water dispensers, air purifiers, and any common electrical devices (e.g. one or more lights, light measurement controllers, air conditioners, fans, kitchen devices, and the like). The IoT devices may be connected to the IoT based panel system (100) to transmit either power or signal, or both power and signal from the cable module (400) of the IoT based panel system (100). Moreover, the IoT devices may be attached on the IoT based panel system (100) without transmitting power or signal to the cable module (400) of the IoT based panel system (100).

As used herein, the terms “connect”, “connecting”, “connection”, “connected”, “in connection with”, “mount”, “mounting”, “mounted”, “attach”, “attaching”, “attachment”, “attached” should be interchangeably and broadly construed to mean in direct connection with or in connection with via one or more elements whether or not power and/or signal are transmitted between such elements.

Hereafter, embodiments of the invention are elucidated to show details of the invention by way of explanatory embodiments. The breadth and scope of the present invention should be defined only in accordance with the claims and their equivalents issuing from this disclosure.

In one embodiment of the invention, an IoT based panel system (100), comprising:
a supporting panel (200);
at least one mounting module (300) installed on the supporting panel (200) for mounting IoT devices thereon;
at least one cable track (350) formed at at least one edge of the mounting module (300) for supporting a cable module (400);
the cable module (400) installed in the cable track (350), where the cable module (400) comprises at least one cable (402) and at least one junction unit (404);
   wherein the cable module (400) is fully or partially installed in the cable track (350) in a predetermined direction to transmit power and signal to an adjustably predetermined position of the IoT devices.

In an exemplary embodiment, a number of mounting modules (300) is equal to or greater than a number of the IoT devices, where the mounting modules (300) are adjustably installed at a predetermined position according to the adjustably predetermined position of the IoT devices.

In another exemplary embodiment, the predetermined direction of the cable module (400) is configured to line up with the predetermined position of the mounting modules (300).

In another exemplary embodiment, the IoT based panel system (100) further comprises at least one additional panels (202) attached to back-to-back of the supporting panel (200).

In another exemplary embodiment, the IoT based panel system (100) further comprises a securing means (206) to securely attach supporting panels (200) with additional panels (202).

In another exemplary embodiment, the securing means (206) comprises at least one vertical securing means (206a) and at least one horizontal securing means (206b).

In another exemplary embodiment, the supporting panel (200) and additional panel (202) are same or different size.

In another exemplary embodiment, the IoT based panel system (100) further comprises an insulating material (204) provided between the supporting panels (200) and the additional panel (202). In a preferred exemplary embodiment, the cable (402) and the junction unit (404) are printed circuit board (PCB).

In another exemplary embodiment, the cable (402) comprises
two connecting parts (406) located at both end of the cable (402);
a first conductive material layer (502);
an insulation layer (503) attached under the first conductive material layer (502);
a second conductive material layer (504), attached under the insulation layer (503), where the second conductive material layer (504) comprises a ground plane and a power plane.

In another exemplary embodiment, the cable (402) further comprises mask layers (510) disposed on the first conductive material layer (502) and on the second conductive material layer (504) for preventing oxidation of the conductive material.

In another exemplary embodiment, the junction unit (404) comprises
at least three connecting parts (406) located at the end of the junction unit (404);
a first conductive material layer (602), where the first conductive material layer (602) comprises a power plane;
an insulation layer (603) attached under the first conductive material layer (602);
a second conductive material layer (604), attached under the insulation layer (603), where the second conductive material layer (604) comprises a ground plane.

In another exemplary embodiment, the junction unit (404) further comprises mask layers (610) disposed on the first conductive material layer (602) and on the second conductive material layer (604) for preventing oxidation of the conductive material.

In another exemplary embodiment, the junction unit (404) further comprises at least one circuit switching unit (620) configured to switch a signal path on the junction unit.

In another exemplary embodiment, the connecting part (406) comprises at least one pin of Voltage Common Collector (VCC), at least one pin of ground (GND), and at least one pin of signal.

In a preferred exemplary embodiment, the connecting part (406) comprises 3-pin Voltage Common Collector (VCC), 4-pin ground (GND), and 4-pin signal.

In another exemplary embodiment, a type of the signal is selected from RS-232, RS-422, RS-423, RS-485, I2C, Ethernet, SDI-12, 1-Wire or combination thereof.

In a preferred exemplary embodiment, the type of the signal is RS-485.

It should be understood that examples of the invention described hereinafter have been presented by way of explanatory and exemplary embodiments of the present invention only. Thus, the breadth and scope of the present invention should be defined only in accordance with the claims and their equivalents issuing from this disclosure.

### EXAMPLE EMBODIMENTS

These example embodiments of the invention will now be described below with reference to the accompanying drawings, which form a part of the present disclosure.

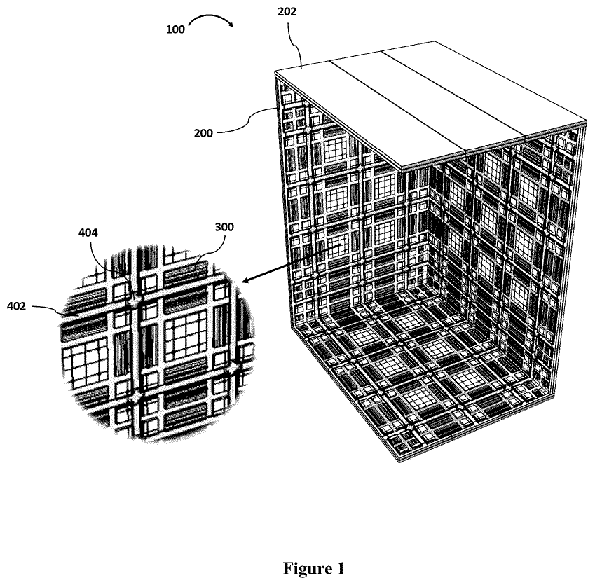

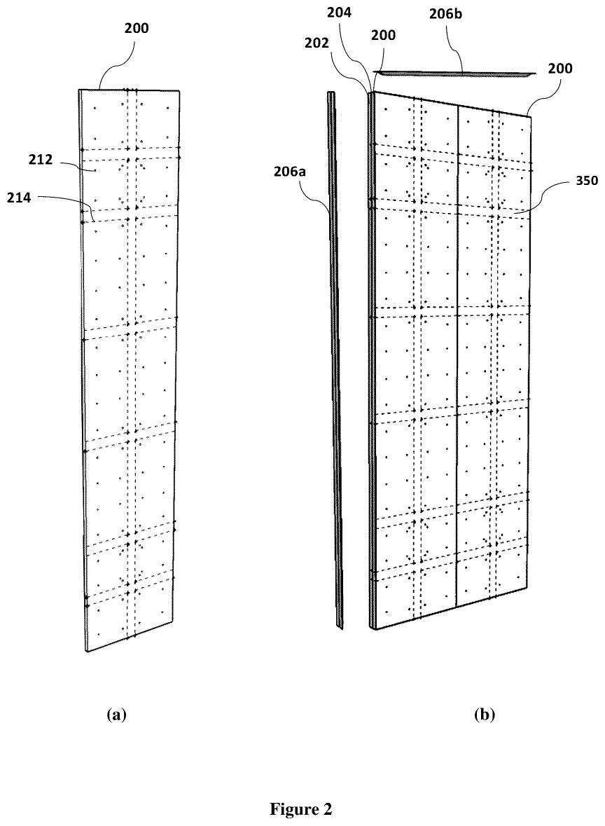

FIG. 1 shows a perspective view of an IoT based panel system (100) according to the exemplary embodiments of the invention. The IoT based panel system (100) comprises a supporting panel (200), at least one mounting module (300) installed on the supporting panel (200) for mounting IoT devices thereon, at least one cable track (350) located at edges of the mounting module (300) for supporting a cable module (400) (as shown in FIG. 2), and the cable module (400) installed in the cable track (350), where the cable module (400) is configured to transmit power and signal to the IoT devices. A plurality of the IoT based panel system (100) may be assembled serially adjacent to form a larger size of panel, such as wall, ceiling or floor. In addition, the IoT based panel system (100) may be installed on a traditional wall of building to improve the traditional wall to have a functionality of the IoT based panel system (100). The IoT based panel system (100) may also be arranged to form an angle in the range of 5 to 180 degree, so that the IoT based panel system (100) can be formed a corner and/or a room with any shapes according to user purpose. For example, the first IoT based panel system (100) may be arranged to form a wall on one side (1st side) of the room and the second IoT based panel system (100) may be arranged to form a wall on the adjacent side (2nd side) of the 1st side in order to create a corner for mounting any IoT devices.

The mounting modules (300) are installed on the supporting panel (200) in accordance with predetermined position for mounting the IoT devices, where there are gaps between the mounting modules (300) to form the cable track (350). Those gaps are used to arrange the cable tracks (350) for supporting installation of the cable module (400). The cable module (400) comprises at least one cable (402) and at least one junction unit (404), connecting in a manner of array connection for transmitting power and signal. After installation of the IoT based panel system (100) is done, a user provides the IoT devices to mount on the mounting module (300) and connect those devices to the cable module (400) in a manner of plug and play. Moreover, the cable (402) and the junction unit (404) are preferably formed by printed circuit boards (PCB) to connect with the IoT devices rather than traditional cable connecting part, with transmitting power and signal through the PCB, all of the IoT devices can be controlled and can function at the same time.

FIG. 2 shows a perspective view of the supporting panel (200) and an additional panel (202) according to the exemplary embodiments of the invention. The additional panel (202) is attached back-to-back of the supporting panel (200). Each supporting panel (200) may comprise at least one hole (212) for holding the mounting module (300), and at least one reference line (214) for predetermining the position of mounting module (300) to be installed. The supporting panel (200) is designed, such as in the form of rectangular shape with specific dimension, a length in the range of 600 to 3000 mm and a width in the range of 200 to 1200 mm and a thickness in the range of 30 to 300 mm

In use case, the supporting panel (200) and the additional panel (202) can be different size both length and width. However, usually the length of the supporting panel (200) corresponds to the height of an installation room. If the user arranges the supporting panel (200) to fit with the height of the installation room, a plurality of smaller additional panel (202) may be used to assemble to comply with the dimension of the supporting panel (200).

The IoT based panel system (100) further comprises at least one vertical securing means (206a) and at least one horizontal securing means (206b) to secure between the supporting panel (200) and the additional panel (202), and reinforce the IoT based panel system (100), where the securing means (206) may be mechanical parts such as mounting track or locking bolt. The IoT based panel system (100) may comprise an insulating material (204) provided between the supporting panel (200) and the additional panel (202) as a flame retardant, and/or for preventing the loss of heat, and intruding of sound. The insulating material (204) is selected from aerogel, poly(methyl cyanoacrylate), polyurethane, fiberglass or combination thereof.

The supporting panel (200) and the additional panel (202) are not limited to only a rectangular shape, but other geometric shapes such as triangle, circle, trapezoid, honeycomb and the like can also be used, as long as the supporting panel (200) and the additional panel (202) can be assembled and connected in many ways to construct the IoT based panel system (100) efficiently, without any purpose to limit any scope of the invention. The material of the supporting panel (200) and the additional panel (202) may be independently selected from aluminum, fiberglass, steel, stainless steel, cast iron, Poly Vinyl Chloride (PVC), Polyethylene Terephthalate (PET), Polystyrene (PS), Polypropylene (PP), Low Density Polyethylene (LDPE), High Density Polyethylene (HDPE), wood, reinforced rubber, tempered glass, multi-layered material or combination thereof, which needs strength, durability and lightweight to be suitable for installation without heavy-duty tools.

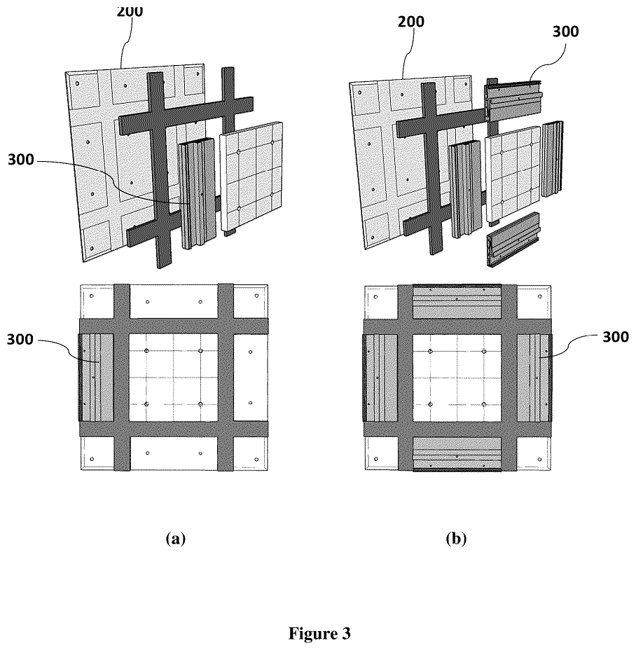

FIG. 3 shows examples of the mounting module (300). The mounting module (300) may be a one-piece structure located on one side of the supporting panel (200) (FIG. 3a), where one side of the structure is installed on the supporting panel (200) and another side has a mounting means to mount the IoT device thereon. Likewise, the mounting module (300) may be configured to locate on the additional panel (202) for mounting the IoT device. With the mounting means the user can mount the IoT devices on the IoT based panel system (100) via the mounting module (300) without the need of using tools (e.g. using a drill and wall screw) to assist in mounting. This makes the IoT device installation on IoT based panel system (100) safer. Alternatively, multiple mounting modules (300) (FIG. 3b) may be located at many or all sides of the supporting panel (200) in order to add more mounting position to mount multiple IoT devices effectively.

A number of mounting modules (300) may be equal to or greater than a number of the IoT devices, where the mounting modules (300) are adjustably positioned to be installed at a predetermined position according to the adjustably predetermined position of the IoT devices. There may be one or more mounting module (300) installed on the supporting panel (200) to support future installation of more IoT devices. The mounting modules (300) may be installed in the position according to the predetermined position of the IoT devices. For example, the mounting modules (300) may be fully installed on the supporting panel (200) at predetermined reference line (214), in actual use, those mounting modules (300) do not need to install all IoT devices thereon because the user may mount with one IoT device at any position of the mounting modules (300). Therefore, the user can select the predetermined position to install IoT device and be able to adjust the position independently.

When the mounting modules (300) are installed on the supporting panel (200) in a manner of array with gap between each other, a plurality of gaps are created and the thickness of the mounting modules (300) causes those gaps to be formed into rectangular tracks in order to be used as the cable tracks (350) for supporting the cable module (400). In an additional case, the cable track (350) may be formed by creating track groove on the supporting panel (200), such as rectangular groove, oval groove, V-groove, J-groove, U-groove, bevel-groove, or combination thereof. The cable track (350) may be added with additional liner such as rubber liner, plastic liner, metal liner, or aluminum liner to be embedded into the cable track (350) for protecting against short circuits between the cable (402) and the material of supporting panel (200). The cable track (350) may have a width from 5 to 50 mm and a depth from 10 to 50 mm, or according to the dimension of the cable (402).

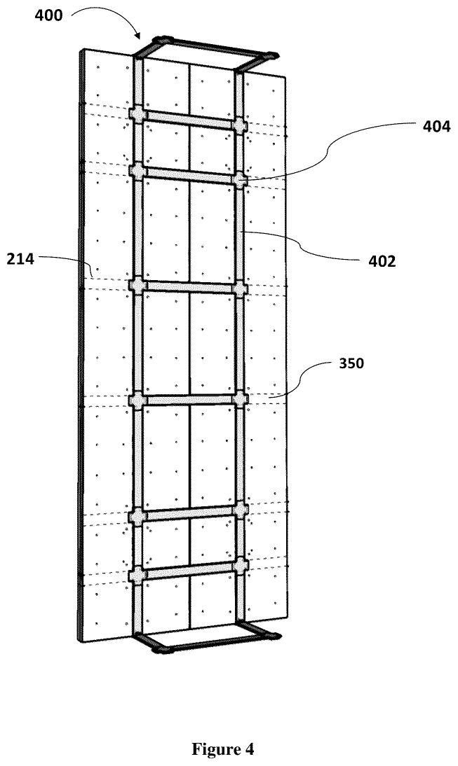

The cable module (400) installed in the cable track (350) comprises at least one cable (402) and at least one junction unit (404) as shown in FIG. 4, where each cable (402) is positioned at the edge of the mounting module (300), while each junction unit (404) is positioned at the corner of the mounting module (300). Those cables (402) and junction units (404) are connected in a manner of array, or any form of arrangement according to the layout of the reference lines (214), for example: horizontal arrangement, vertical arrangement, square arrangement, circular arrangement, or combination thereof. Moreover, the cable (402) and the junction unit (404) may be connected together to form an angle in the range of 5 to 180 degrees for routing the cable (402) to any position. Once the cable module (400) is installed in the cable track (350), an outsource power is connected to the cable module (400) for supplying power.

The cable module (400) may be fully or partially installed in the cable track (350) in a predetermined direction to transmit power and signal to an adjustably predetermined position of the IoT devices, where the predetermined direction of the cable module (400) is configured to systematically line up with the predetermined position of the mounting modules (300). For optimal cost savings, the cable module (400) may be designed with a layout with the shortest direction.

For example, the cable module (400) may be installed in all cable tracks (350) to support a large number of IoT devices to be installed such as in the entertainment room, gaming room, exhibition room, and the likes. In addition, the cable module (400) may also be fully installed in all cable tracks (350) to support additional IoT devices to be installed in the future. Alternatively, the cable module (400) may be installed in some cable tracks (350) (partial installation) to support only limited number of IoT devices so that the cost would be reduced. For specific example, if the user would like to install only three IoT devices, partial installation of the cable module (400) would be sufficient.

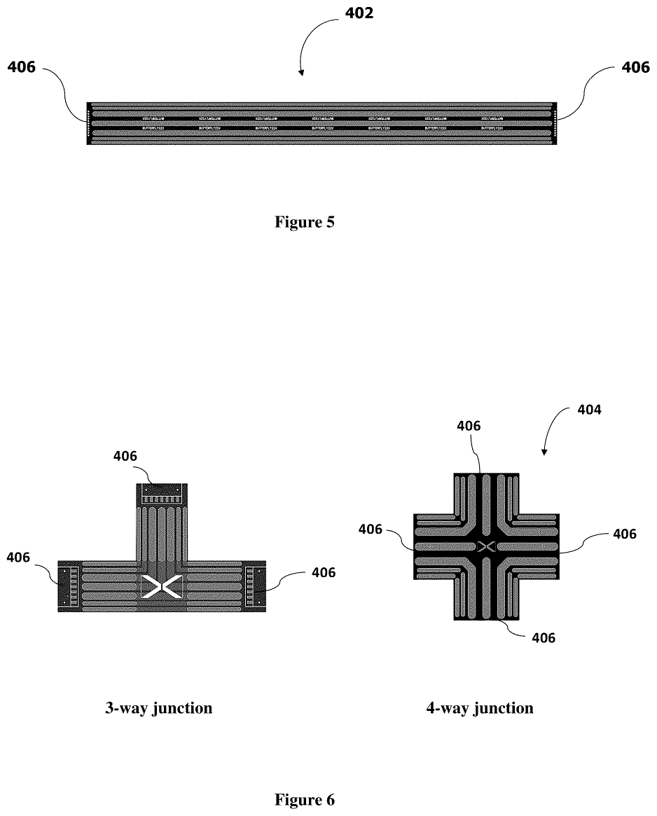

FIG. 5 shows the cable (402) which has two connecting parts (406) located thereon for connecting the cable (402) to the junction unit (404). The cable (402) is used to transmit power and signal throughout the IoT based panel system (100). The cable (402) may be in length from 100 to 1000 mm, and width from 10 to 50 mm.

FIG. 6 shows the junction unit (404) having at least 3 connecting parts (406) that can be formed as 3-way or 4-way junction for connecting the junction unit (404) to the cable (402). The junction unit (404) may be in length from 10 to 500 mm and width from 10 to 500 mm to correspond with the cable.

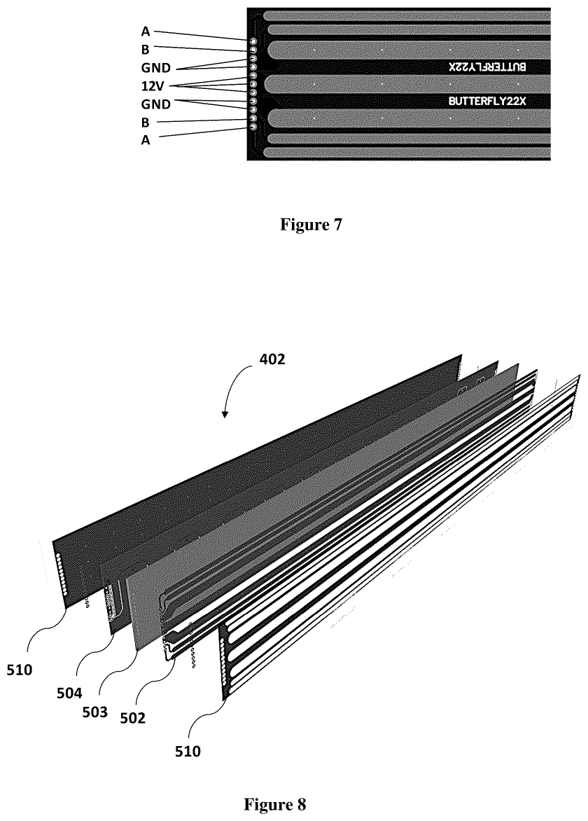

An example of the connecting part (406) is shown in FIG. 7, comprising 7-pin; 3-pin Voltage Common Collector (VCC), 4-pin ground (GND), 4-pin signal. The voltage of VCC can be either 5V DC, 12V DC or 24V DC. The signal may be selected from RS-232, RS-422, RS-423, RS-485, I2C, Ethernet, SDI-12, 1-Wire or combination thereof, preferably RS-485, or can be determined from a specification of the IoT device. Using more than 4-pin signal for data transmission allows the cable module (400) to support connecting up to 100 IoT devices at the same time. The cable (402) and junction unit (404) may be adjusted in accordance with the configuration of the connecting part (406) to support more IoT devices according to the number of IoT devices that users need.

FIG. 8 shows an example structure of the cable (402). The cable (402) is formed by printed circuit boards (PCB) comprising two connecting parts (406), and at least two layers of conductive material comprising: a first conductive material layer (502); a second conductive material layer (504), positioned under the first conductive material layer (502) by attaching with an insulation (503), where the second conductive material layer (504) comprises a ground plane and a power plane; and mask layers (510) disposed on the first conductive material layer (502) and on the second conductive material layer (504) for preventing oxidation of the conductive material.

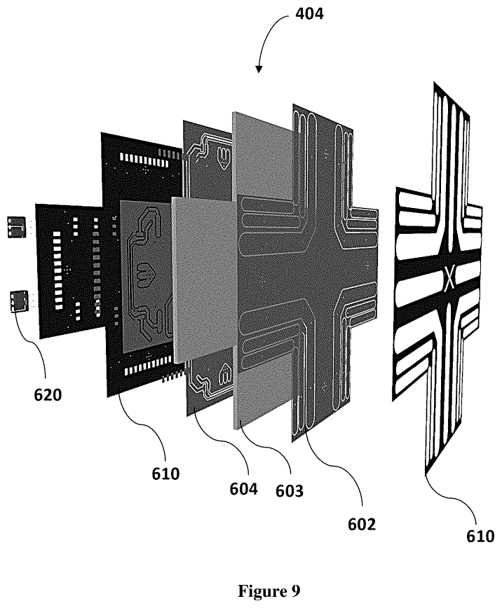

FIG. 9 shows an example structure of the junction unit (404). The junction unit (404) is formed by printed circuit boards (PCB) comprising at least three connecting parts (406) protruding from the junction unit (404), and at least two layers of conductive material comprising: a first conductive material layer (602), where the first conductive material layer (602) comprises a power plane; a second conductive material layer (604), positioned under the first conductive material layer (602) by attaching with an insulation (603), where the second conductive material layer (604) comprises a ground plane; and mask layers (610) disposed on the first conductive material layer (602) and on the second conductive material layer (604) for preventing oxidation of the conductive material. The junction unit (404) further comprises at least one circuit switching unit (620) configured to switch a signal path on the junction unit.

The conductive material allows the electrons flowing through the layer for transmitting electric current of the circuit, where examples of the conductive material include, but are not limited to, aluminum, an aluminum alloy, copper, a copper alloy, tungsten, a tungsten alloy, gold, a gold alloy, silver, a silver alloy or combination thereof. The insulation disclosed in the exemplary embodiments of the invention is not only the layer of insulation that is the same size as the conductive material layer, but the insulation can also be an interposing material used to separate two conductive material layers for preventing short circuit. The insulation can be a material such as fiberglass-epoxy laminate, polytetrafluoroethylene (PTFE), and the like, that is used for, but are not limited to, coating, spraying, painting, airbrushing, or adhering on the conductive material layers in order to function as electrical protection.

Moreover, the cable (402) and the junction unit (404) may be shielded with an additional polymer coating (e.g. PVC) to prevent short circuits and to filter electromagnetic waves that interfere with data communication. The cable (402) and the junction unit (404) described herein in terms of a PCB having two layers are merely exemplary and are not intended to limit the disclosure. Increasing/decreasing the number layers of the PCB for the IoT based panel system (100) as described in the technical concept of this embodiment can be adjusted and it is not considered apart from the scope of the present invention.

Although the present disclosure describes the printed circuit board (PCB) for transmitting power and/or signal to the IoT devices, it is to be understood by a skilled person that the cable (402) and the junction unit (404) may also be other types of electrical cables which are capable of transmitting power and/or signal to the IoT devices, for example, coaxial cable, communications cable, direct-buried cable (DBC), flexible cable, heliax cable, and the like.

### Method of Installing the IoT Based Panel System (100)

For better understanding, an exemplary method of installing the IoT based panel system (100) for using as the wall panel according to the exemplary embodiments of the invention comprises steps of:
i) assembling the supporting panels (200) to form the wall;
ii) arranging the mounting modules (300) at reference lines (214) and installing the mounting modules (300) on the supporting panels (200), where the cable tracks (350) are located at edges of the mounting module (300);
iii) installing the cables (402) in cable tracks (350);
iv) installing the junction units (404) at intersection between horizontal cable track (350) and vertical cable track (350), then connecting those junction units (404) to the cables (402) until they are array connected as the cable module (400);
v) mounting IoT devices on the mounting modules (300);
vi) connecting the cable module (400) to the IoT devices.

The IoT devices may be selected from: a battery storage unit, data storage unit, camera, microphone, speaker, light, spotlight, sound and light measurement controller, wireless controller, monitor, touch screen display, VR controller, VR display, projector, television, kitchen appliances, solar cell, solar panel, computer controller (such as joystick and gaming wheel), mobile controller, charger, water dispenser, air purifier, cooling fan, electric fan, air conditioning unit, heater, heat transfer unit, infrared laser light, or any kind of sensors (e.g. temperature sensor, humidity sensor, force sensor, hall sensor), or any structure material embedded with electronic board, or any kind of IoT device having the same connecting part to connect with previously mentioned cables or junction unit of the present invention, without any purpose to limit any scope of the invention.

All the examples of the IoT based panel system (100) disclosed in this document are not limited to the construction of a wall, but also to construct wall, partition, ceiling and floor for house, office, conference room, education place, gaming room, VR room, hologram room, hospital, operating room, robotic room, testing/experiment room, container, any kind of building, or any type of construction involving walls, ceilings and floors, without any purpose to limit any scope of the invention.

The IoT based panel system (100) can also adjust/modify the material of any components to suit the environment and atmosphere in that area, whether it is used in a normal atmosphere, under the sea level where materials resistant to corrosion are required, or in the case of use in outer space (extremely high vacuum) where lightweight and very strong materials are required. While the property of the material may be changed, and is expected by an ordinary person skilled in the art, the components and functions would not differ from the scope of the present invention.

While an embodiment of the invention has been illustrated and described, it is appreciated that various changes can be made therein without departing from the spirit and scope of the invention.

While various embodiments in accordance with the disclosed principles have been described above, it should be understood that they have been presented by way of example only, and are not limiting. Thus, the breadth and scope of the example embodiments described in the present disclosure should not be limited by any of the above-described exemplary embodiments, but should be defined only in accordance with the claims and their equivalents issuing from this disclosure. Furthermore, the above advantages and features provided in the described embodiments shall not limit the application of such issued claims to processes and structures accomplishing any or all of the above advantages.

### BEST MODE OR PREFERRED EMBODIMENT OF THE INVENTION

Best mode or preferred embodiment of the invention is as provided in the description of the invention.

1. An IoT based panel system (100), comprising:
a supporting panel (200);
at least one mounting module (300) installed on the supporting panel (200) for mounting IoT devices thereon;
at least one cable track (350) formed at at least one edge of the mounting module (300) for supporting a cable module (400);
the cable module (400) installed in the cable track (350), where the cable module (400) comprises at least one cable (402) and at least one junction unit (404);
wherein the cable module (400) is fully or partially installed in the cable track (350) in a predetermined direction to transmit power and signal to an adjustably predetermined position of the IoT devices.

2. The IoT based panel system (100) according to claim 1, wherein a number of mounting modules (300) is equal to or greater than a number of the IoT devices, where the mounting modules (300) are adjustably installed at a predetermined position according to the adjustably predetermined position of the IoT devices.

3. The IoT based panel system (100) according to claim 1, wherein the predetermined direction of the cable module (400) is configured to line up with the predetermined position of the mounting modules (300).

4. The IoT based panel system (100) according to claim 1, wherein the IoT based panel system (100) further comprises at least one additional panel (202) attached back-to-back of the supporting panel (200).

5. The IoT based panel system (100) according to claim 4, wherein the IoT based panel system (100) further comprises a securing means (206) to securely attach supporting panels (200) with additional panels (202).

6. The IoT based panel system (100) according to claim 5, wherein the securing means (206) comprises at least one vertical securing means (206a) and at least one horizontal securing means (206b).

7. The IoT based panel system (100) according to claim 4, wherein the supporting panel (200) and additional panel (202) are the same or different size.

8. The IoT based panel system (100) according to claim 4, wherein the IoT based panel system (100) further comprises an insulating material (204) provided between the supporting panel (200) and the additional panel (202).

9. The IoT based panel system (100) according to claim 1, wherein the cable (402) and the junction unit (404) are printed circuit board (PCB).

10. The IoT based panel system (100) according to claim 1, wherein the cable (402) comprises
two connecting parts (406) located at both end of the cable (402);
a first conductive material layer (502);
an insulation layer (503) attached under the first conductive material layer (502);
a second conductive material layer (504), attached under the insulation layer (503), where the second conductive material layer (504) comprises a ground plane and a power plane.

11. The IoT based panel system (100) according to claim 10, wherein the cable (402) further comprises mask layers (510) disposed on the first conductive material layer (502) and on the second conductive material layer (504) for preventing oxidation of the conductive material.

12. The IoT based panel system (100) according to claim 1, wherein the junction unit comprises
at least three connecting parts (406) located at the end of the junction unit (404);
a first conductive material layer (602), where the first conductive material layer (602) comprises a power plane;
an insulation layer (603) attached under the first conductive material layer (602);
a second conductive material layer (604), attached under the insulation layer (603), where the second conductive material layer (604) comprises a ground plane.

13. The IoT based panel system (100) according to claim 12, wherein the junction unit (404) further comprises mask layers (610) disposed on the first conductive material layer (602) and on the second conductive material layer (604) for preventing oxidation of the conductive material.

14. The IoT based panel system (100) according to claim 12, wherein the junction unit (404) further comprises at least one circuit switching unit (620) configured to switch a signal path on the junction unit.

15. The IoT based panel system (100) according to claim 10, wherein the connecting part (406) comprises at least one pin of Voltage Common Collector (VCC), at least one pin of ground (GND), and at least one pin of signal.

16. The IoT based panel system (100) according to claims 15, wherein the connecting part (406) comprises 3-pin Voltage Common Collector (VCC), 4-pin ground (GND), and 4-pin of signal.

17. The IoT based panel system (100) according to claim 15, wherein a type of the signal is selected from RS-232, RS-422, RS-423, RS-485, 12C, Ethernet, SDI-12, 1-Wire or combination thereof.

18. The IoT based panel system (100) according to claim 17, wherein the type of the signal is RS-485.

19. The IoT based panel system (100) according to claim 12, wherein the connecting part (406) comprises at least one pin of Voltage Common Collector (VCC), at least one pin of ground (GND), and at least one pin of signal.
